(19) United States
(12) Patent Application Publication
(10) Pub. No.: US 2026/0012898 A1
(43) Pub. Date: Jan. 8, 2026

(54) POWER CONTROL OVER MULTI-PANEL SIMULTANEOUS TRANSMISSIONS IN WIRELESS SYSTEMS

(71) Applicant: InterDigital Patent Holdings, Inc., Wilmington, DE (US)

(72) Inventors: Virgil Comsa, Montreal (CA); Afshin Haghighat, Ile-Bizard (CA); Jonghyun Park, Syosset, NY (US); Dylan Watts, Montreal (CA); Moon IL Lee, Melville, NY (US)

(73) Assignee: InterDigital Patent Holdings, Inc., Wilmington, DE (US)

(21) Appl. No.: 18/879,983

(22) PCT Filed: Sep. 22, 2023
(86) PCT No.: PCT/US2023/074880

§ 371 Date: Dec. 30, 2024

Related U.S. Application Data
(60) Provisional application No. 63/411,282, filed on Sep. 29, 2022.

(51) Int. Cl. H04W 52/36; H04B 7/06

(52) U.S. Cl. CPC H04W 52/365; H04B 7/06952; H04W 52/367

(57) ABSTRACT

A wireless transmit/receive unit (WTRU) may receive a first set of simultaneous uplink (UL) grants for transmitting first simultaneous transmissions using a first set of two or more beams. The WTRU may transmit a first power headroom report (PHR) including a first power sharing indication. The first power sharing indication may indicate a first power sharing status for the first simultaneous transmissions. The WTRU may receive a second set of simultaneous UL grants for transmitting second simultaneous transmissions. The second simultaneous transmissions may be transmitted using a second set of two or more beams. The WTRU may determine a second power sharing status for the second simultaneous transmissions. The WTRU may transmit a second PHR when the determined second power sharing status is different than the first power sharing status.

### TO RELATED APPLICATIONS

This application claims the benefit of U.S. Provisional Patent Application No. 63/411,282 filed on Sep. 29, 2022, the entire contents of which are incorporated herein by reference.

### BACKGROUND

The present disclosure relates generally to power control over panel transmission. Specifically, the present disclosure relates to power control over multi-panel simultaneous transmissions in wireless systems.

Mobile communication systems have been designed to provide voice services while ensuring user activity. However, the coverage of mobile communication services has expanded to data services in addition to voice services, and the rapid growth of traffic resulted in a lack of resources as well as user demand for high-speed services requiring advanced mobile communication systems. The requirements of the next generation mobile communication system may include support for huge data traffic, a significant increase in the transmission speed of each user, placement of a significantly increased number of connection devices, very low end-to-end delay time and high energy efficiency.

To meet the demand for the increased wireless data traffic since deployment of 4G communication systems, efforts have been made to develop an improved 5G or pre-5G communication system. Consequently, the 5G or pre-5G communication system is also called a ‘Beyond 4G Network’ or a ‘Post LTE System’. The 5G communication system is considered to be implemented in higher frequency (e.g., mmWave) bands, such as 60 GHz bands, in order to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. Furthermore, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

### BRIEF SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to one exemplary aspect, the disclosure relates to a Wireless Transmit/Receive Unit (WTRU) that includes a processor and memory, that may be configured to determine one or more panel groups (Pgs) based on one or more parameters. The WTRU may be configured to determine one or more panel group (Pg) power capabilities, for example based on the one or more Pgs. The WTRU may be configured to send Pg information, for example based on the determined one or more Pg power capabilities and/or power sharing information.

According to an exemplary aspect, the WTRU may be configured to determine power information when power limitation conditions are met. The power information may include one or more of maximum power reduction (MPR), maximum output power (Pcmax) for one or more beam direction, beam,i derivation, and/or application rules. The WTRU may be configured to switch a panel to an RF chain, for example based on receiving an indication to switch the panel to the RF chain.

A WTRU may receive a first set of simultaneous uplink (UL) grants. The first set of simultaneous UL grants may be for transmitting first simultaneous transmissions, for example using a first set of two or more beams. The WTRU may transmit a first power headroom report (PHR). The first PHR may include a first power sharing indication. The first power sharing indication may indicate a first power sharing status, for example for the first simultaneous transmissions. The WTRU may receive a second set of simultaneous UL grants, for example for transmitting second simultaneous transmissions. The second simultaneous transmissions may be transmitted using a second set of two or more beams. The WTRU may determine a second power sharing status, for example for the second simultaneous transmissions. The WTRU may transmit a second PHR, for example when the determined second power sharing status is different than the first power sharing status.

The second PHR may include a second power sharing indication. The second power sharing indication may indicate the second power sharing status, for example for the second simultaneous transmissions. The first PHR may include a first maximum power. The first maximum power may be associated with a first beam and/or a second maximum power associated with a second beam. The first beam and/or the second beam may be included in the first set of two or more beams.

The second PHR may include a third maximum power. The third maximum power may be associated with a third beam and/or a fourth maximum power. The fourth maximum power may be associated with a fourth beam. The third beam and/or the fourth beam may be included in the second set of two or more beams. A value of the first power sharing status and/or the second power sharing status may indicate true or false. The first beam and the third beam may include the same beam. The first set of two or more beams may be included in a first panel group. A value of a first power sharing status may be based on the first set of two or more beams being included, for example in a first panel group. The value of the first power sharing status may be additionally, or alternatively, based on an angle between the two or more beams. Simultaneous transmissions may overlap in the time domain. For example, simultaneous transmissions may be transmissions that overlap in time, transmissions that partially overlap in time, and/or slightly offset transmissions, for example, due to timing advances.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of possible cases for panel grouping/layouts.

FIG. 3 is a diagram illustrating an example scenario where beams are served by 2 panel groups.

FIG. 4 is a diagram illustrating another example scenario where beams are served by 2 panel groups.

FIG. 5 is a flow diagram illustrating an example procedure of panel group power sharing.

FIG. 6 is a diagram illustrating an example of a definition of a single entry PHR.

FIG. 7 is a diagram illustrating an example of an extended PHR version.

FIG. 8 is a diagram illustrating an example of perfect overlapping RB allocations in frequency domain.

FIG. 9 is a diagram illustrating an example of overlapping RB allocations with different sizes in frequency domain.

FIG. 10 is a diagram illustrating an example of non-overlapping RB allocations in frequency domain.

FIG. 11 is a diagram illustrating an exemplary implementation of a multi-panel WTRU with multiple antenna groups per panel.

FIG. 12 is a table illustrating an exemplary set of power rating per panel, per antenna group.

FIG. 13 is a diagram illustrating an example of a multi-panel WTRU with antenna switch capability.

### DETAILED DESCRIPTION

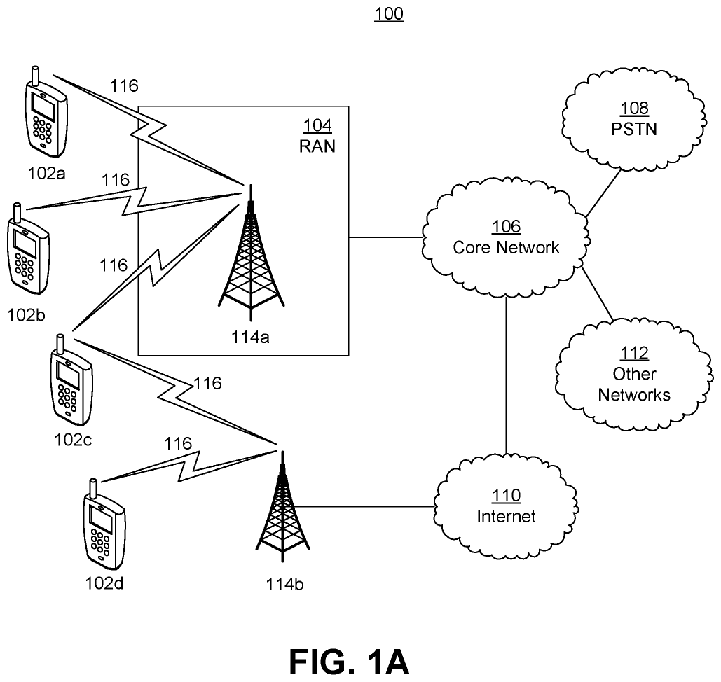

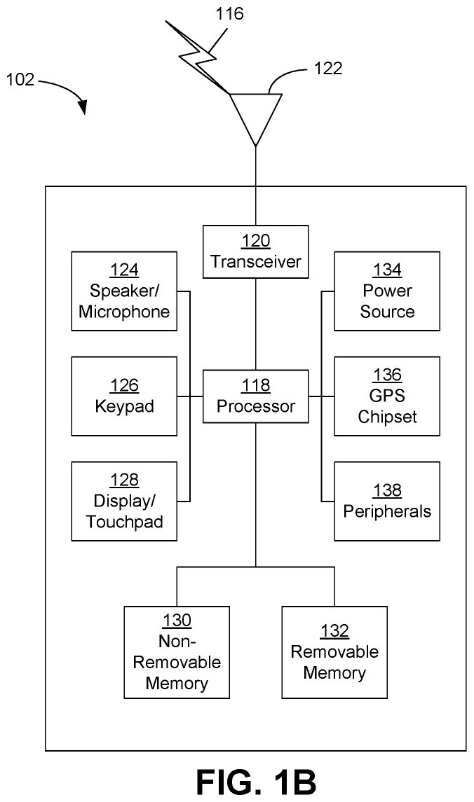

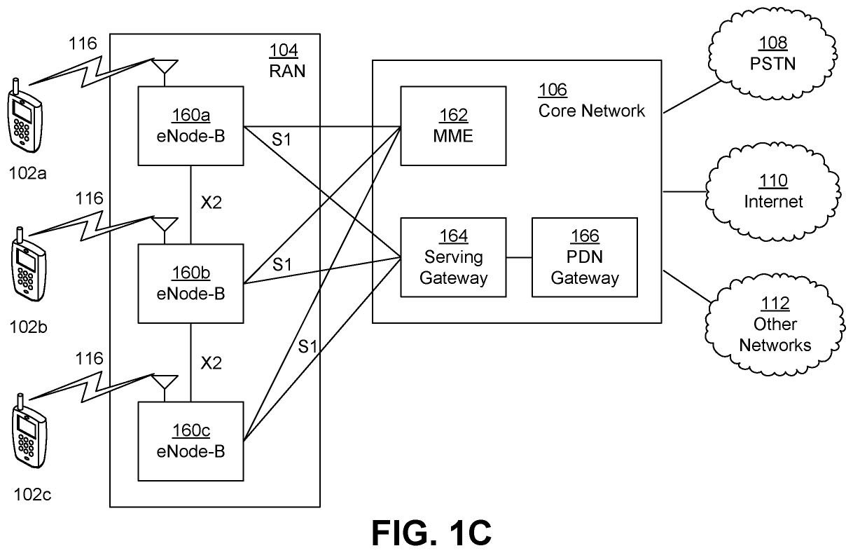

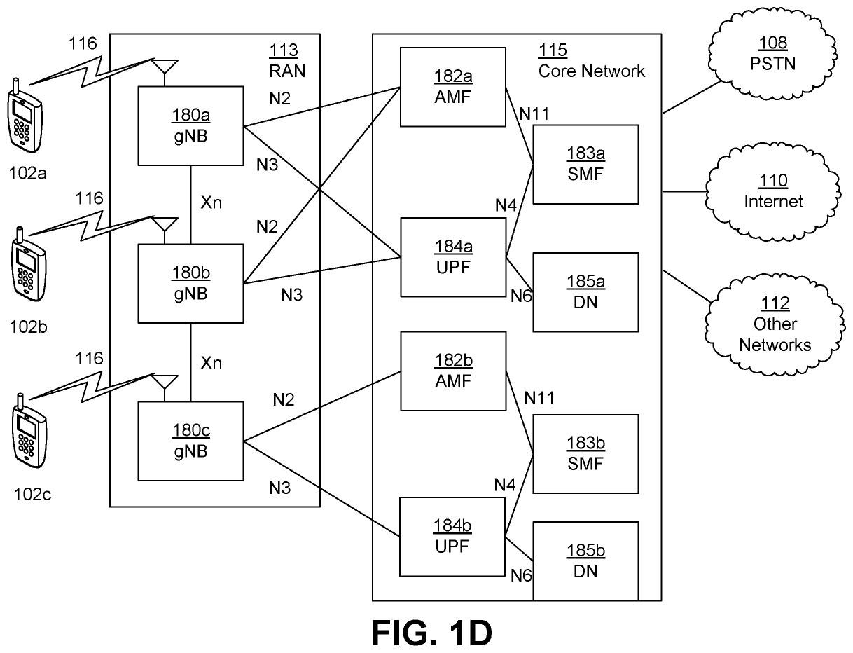

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive a first set of simultaneous uplink (UL) grants. The first set of simultaneous UL grants may be for transmitting first simultaneous transmissions, for example using a first set of two or more beams. The WTRU may transmit a first power headroom report (PHR). The first PHR may include a first power sharing indication. The first power sharing indication may indicate a first power sharing status, for example for the first simultaneous transmissions. The WTRU may receive a second set of simultaneous UL grants, for example for transmitting second simultaneous transmissions. The second simultaneous transmissions may be transmitted using a second set of two or more beams. The WTRU may determine a second power sharing status, for example for the second simultaneous transmissions. The WTRU may transmit a second PHR, for example when the determined second power sharing status is different than the first power sharing status.

The second PHR may include a second power sharing indication. The second power sharing indication may indicate the second power sharing status, for example for the second simultaneous transmissions. The first PHR may include a first maximum power. The first maximum power may be associated with a first beam and/or a second maximum power associated with a second beam. The first beam and/or the second beam may be included in the first set of two or more beams.

The second PHR may include a third maximum power. The third maximum power may be associated with a third beam and/or a fourth maximum power. The fourth maximum power may be associated with a fourth beam. The third beam and/or the fourth beam may be included in the second set of two or more beams. A value of the first power sharing status and/or the second power sharing status may indicate true or false. The first beam and the third beam may include the same beam. The first set of two or more beams may be included in a first panel group. A value of a first power sharing status may be based on the first set of two or more beams being included, for example in a first panel group. The value of the first power sharing status may be additionally, or alternatively, based on an angle between the two or more beams. Simultaneous transmissions may overlap in the time domain. Simultaneous transmissions may be transmissions that overlap in time, transmissions that partially overlap in time, and/or slightly offset transmissions, for example, due to timing advances.

Multi-transmission/reception points (mTRP) include TRPs that share the same physical cell identity (PCI). A unified transmission configuration indicator (TCI) concept may allow for a faster and/or more efficient management of the TCI states and beam management. The reception from the TRPs may include a cyclic prefix. The cyclic prefix may allow for a (e.g., full) timing synchronization assumption, for example between the TRPs. In an example, no simultaneous transmissions from multiple panels may be allowed, and/or the power control may be unaffected.

Deployments may be diversified, for example by utilizing (e.g., two) timing advance (TA) loops. For example TA loops may be utilized with one or more of (e.g., two) non-collocated TRPs, (e.g., two) WTRU panels, (e.g., maximum of 4) UL MIMO layers, (e.g., two) layers per panel, mDCI (multi DCI) reception, simultaneous/overlapping PUSCH+PUSCH, and/or PUCCH-PUCCH UL transmissions.

Different approaches for power limitations may be used for WTRU power control, for example for ST×MP. Power limitation may be used per panel (e.g., for ST×MP). A total power limitation per WTRU over all WTRU panels may be used (e.g., for ST×MP). Different approaches may include (e.g., lead to) different rules and/or calculations.

In a WTRU RF specification for example, the Pcmax for UL MIMO may include a configured maximum output power P_{CMAX,c} for serving cell c. The configured maximum output power may be a sum of all streams and/or may be bound by limit(s). The Pcmax for UL MIMO may be for WTRUs configured for 2-layer transmission and/or WTRUs configured for single layer uplink full power transmission (ULFPTx). Single carrier Pcmax may include the WTRU configuring its maximum output power. The configured WTRU maximum output power P_{CMAX,f,c} for carrier f of a serving cell c may include power available to a reference point, for example of a (e.g., given) transmitter branch. The reference point may correspond to a reference point of a higher-layer filtered RSRP measurement.

The configured WTRU maximum output power P_{CMAX,f,c} for carrier f of a serving cell c may include a value (e.g., be set) such that the corresponding measured peak EIRP P_{UMAX,f,c} may be within bounds. For example, the corresponding measured peak EIRP P_{UMAX,f,c} may be within bounds including P_{Powerclass}+DP_{IBE}−MAX(MAX(MPR_{f,c}, A-MPR_{f,c,})+ΔMB_{P,n}, P-MPR_{f,c})−MAX{T(MAX(MPR_{f,c}, A-MPR_{f,c,})), T(P-MPR_{f,c})}≤P_{UMX,f,c}≤EIRPₘₐₓ. The corresponding measured total radiated power P_{TMAX,f,c} may be bounded by P_{TMAX,f,c}≤TRPₘₐₓ. Pcmax may be measured at a reference point in space that, for example may be linked to the higher layer filtered RSRP. A pathloss may be defined for the desired and/or unique direction/beam of transmission. A UL MIMO Pcmax requirement may include (e.g., be limited to) two layer transmissions. A UL MIMO Pcmax requirement may target 4 layer transmission and/or may use (e.g., up to two) code words across all panels. Examples herein may apply to one or more of FWA (fixed wireless access), CPE (customer premises equipment), vehicular, and/or industrial device types of WTRUs. Example devices (e.g., device types) may have different power classes, and/or may have different antenna panel designs. For example, for vehicular type, a Distribution Panel System (DAS) may be employed and/or may have panels distributed on (e.g., four) sides of the roof of the car. Panels may cover in a combined mode 360 degrees in azimuth, and/or 0-80 or 90 degrees in elevation. There may be a potential per panel and/or per WTRU power limitation. There may be (e.g., both) a power limitation per panel for ST×MP and/or a total power limitation per WTRU, for example over all WTRU panels used for ST×MP. One or more devices types may combine their panels, for example at a (e.g., certain) level. Panels may combine to achieve a (e.g., certain) directivity. There may not be a clear directivity split for panels. A (e.g., certain) grouping of panel ports may be associated with SRI resources may be utilized, for example to compute the total power per allocated ports.

One or more panel ports grouping may be associated with a WTRU capability, for example, when an ST×MP feature is supported under a multi-DCI scenario. A single transmission in a single direction/beam may be allowed. A Pcmax, for example, in WTRU RF specification for FR2 (e.g., frequencies above 24 GHz) may be associated with (e.g., governed by) one or more of EIRPmin, EIRPmax, and/or TRPmax limits. A spherical coverage requirement may be associated with beam steering capabilities of the WTRU.

Scaling procedures and/or priorities solutions are disclosed herein. For example, in a transmission system with multiple TAs, where for example the receptions and transmissions may go beyond a CP (cyclic prefix), the overlapping simultaneous UL transmissions over multiple panels (e.g., ST×MP) with a maximum of four layers and/or two codewords may pose a new challenge for power control.

One or more groupings of panel ports associated with SRI resources may be configured to compute the total power, for example per allocated ports. A panel grouping may be reported to the network, for example including and/or based on power class capabilities and/or power sharing. Power control procedures are disclosed herein. For example, when it is feasible for there to be (e.g., both) a power limitation per panel for ST×MP and/or a total power limitation per WTRU over all WTRU panels used for ST×MP, power control procedures may be utilized. Coexistence mitigation measures (e.g., maximum power reduction (MPR)) may be applied, for example in the context of ST×MP.

A WTRU may have capabilities for ST×MP within a multi-DCI context. There may be one or more gNB scheduler parameters. The gNB scheduler parameters may include one or more of the WTRU maximum power and/or how the WTRU maximum power may be achieved (e.g. per panel and/or per WTRU). The one or more gNB parameters may send a message to (e.g., inform) the scheduler as to how one or more of MPR, A-MPR, and/or P-MPR are applied. The one or more gNB parameters may be configured for (e.g., allow for) an uplink grant scheduling convergence, for example in terms of coverage and/or target BLER.

A WTRU may have capabilities for panel grouping and/or panel group power sharing. For example under multi-TRP scenarios, the WTRU may support 2 sets of power control parameters (e.g., for the UL multi-TRP case). Simultaneous UL transmissions from multiple panels (e.g., ST×MP) may be addressed. Panel grouping may be considered. The panel grouping may determined, at least partially, by panel design characteristics. Panel design characteristics may include one or more of coherence, non-coherence, panel layout, groups of panels capable of serving a common beam, and/or groups of panels capable of serving a TCI. The term panel group (Pg) may be used generically herein. A panel group as described herein may include one or more panels.

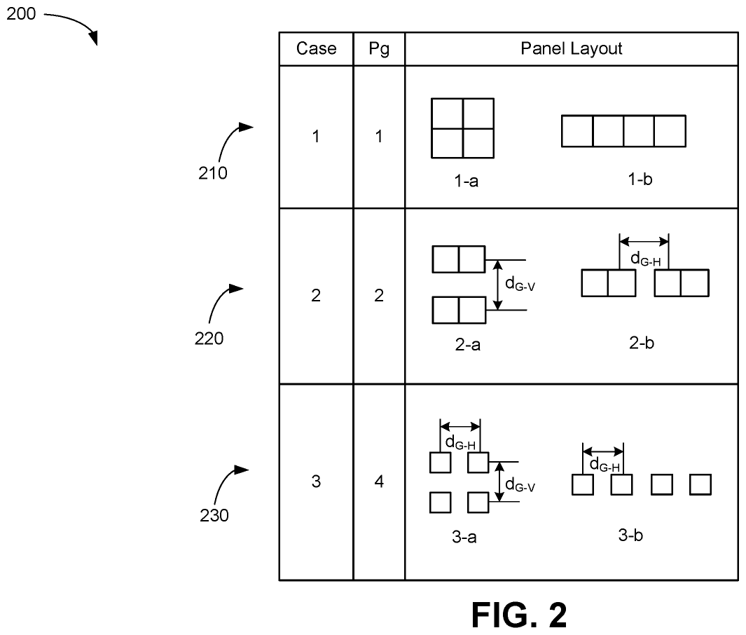

There may be one or more panel grouping/layouts. FIG. 2 is an example table 200 that depicts examples of possible panel groupings and/or layouts. For example, in FIG. 2, three cases 210, 220, 230 are described for 1, 2 or 4 panel groups and associated layouts. For example, case 3 at 230 may be associated with a vehicular device. The device may have 4 distinct panels, for example for each direction 90 degrees from each other in horizontal plane for a total 360 degrees in azimuth coverage. There may be a WTRU capability, for example describing the number of panel groups that may be supported by the WTRU and/or how two simultaneous UL power may be computed. The power sharing capability may include the maximum number of panel groups that may share the power at EIRP level and/or a number or panel groups serving the same beam or TCI.

The total power EIRP for an UL beam supporting UL MIMO may be determined based on (e.g., computed as a sum of) the powers over all power allocated ports. The PUSCH and/or PUCCH power may be split, for example between the non-zero allocated panel ports. It may be important to know whether or not the SRS and/or SRI resources are equally spread along the panel groups, and/or whether or not the SRS or SRI resources may become unbalanced, for example, due to beam serving by a single and/or multiple panel group.

A WTRU may declare 4 panel groups (Pg) at 230 and/or, for example, a maximum of 2 Pg may serve a beam. The panel group power capability may be associated with one or more of the WTRU category, power class category, and/or global requirement (e.g., minimum EIRP, maximum EIRP, and/or max TRP). For example, a WTRU may declare 4 Pg, max 2 Pg beam serving, and/or each panel group may reach full power class on its own. In some examples, if 2 Pg are serving the same beam (e.g. and/or TCI), it may be interpreted as 2 Pg sharing the power and/or may be bounded by a single EIRP/TRPmax requirement. The indication may be a signaling bit Pg, max power sharing that may include one or more of panel groups Pg=4 at 230; beam serving max Pg, max=2; Pg, and/or max Power Sharing=0 or 1 (e.g., false or true).

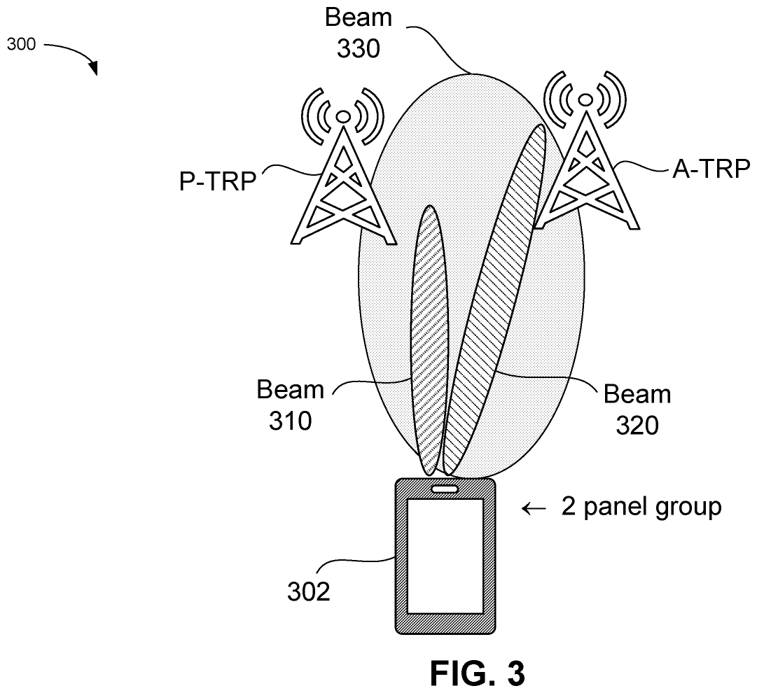

FIG. 3 is a diagram showing an example scenario 300 of beams. One or more of beam 310, beam 320, and beam 330 may be served by 2 panel groups 302. The 2 panel groups 302 may be individually capable of power class versus Pg, max power sharing, which for example may have a True or False parameter. For example, if PG, max power sharing is true, each declared beam serving panel group may reach (e.g., individually) the power class requirements for the WTRU power category (e.g., when serving the same beam/TCI (ex: Pg, max=2)). The power class requirements may be (e.g., globally) capped to the EIRPmax and/or TRPmax. Power sharing between different beams may be utilized. Beam 330 may be served in ST×MP by a panel group that shares EIRP power. Alternatively, or additionally, if beam 310 and beam 320 are served by a panel group where each is capable of full power class and/or the WTRU is configured to utilize EIRP power sharing, then Pg,max power sharing=True may be declared for example (e.g., there may be power sharing). If Pg, max power sharing is False, the declared beam serving Pg,max panel groups may reach (e.g., only) globally (e.g., all together over all active beams) the power class requirements for the WTRU power category, for example when serving the same beam/TCI. Power sharing between the beams may not be required. Beam 330 may be served in ST×MP by a panel group that may not share EIRP power, for example as they may be reaching only collectively the power class levels. Alternatively, or additionally, for example based on the WTRU antenna/panel implementation, the WTRU determine power sharing generally. For example, regarding power sharing the WTRU may determine that EIRPmax and/or TRPmax may be shared individually or collectively, and/or that the power sharing indication may involve certain actions from the WTRU that may be reflected in the Pcmax calculation. Solutions presented herein may allow for such flexibility.

A combination of parameters for the WTRU panel and/or power capabilities may be used in relation to ST×MP for multi-TRP, for example in a mDCI scenario. One or more parameters may be chosen. The parameters may include one or more of support of beyond a CP UL 2×Tx (e.g., each Tx represents a group of panels) with overlapping for mDCI case for multi-TRP; support of 2 FTT modules, a radio chain(s); a support gap or no gap (e.g., required) for measurements (e.g., this may be equivalent to 2 FFT modules and Radio Chains); panel groups (e.g., 1, 2, 4, . . . ); beam serving max Pg (Pg,max<=Pg); and/or Pg,max power sharing.

The WTRU may indicate (e.g., explicitly) the (e.g., maximum) number of simultaneous beams that may serve. The WTRU may indicate (e.g., explicitly) each possible panel group combination characteristics in terms of power sharing. For example, the WTRU may indicate (e.g., explicitly) measurements capabilities. The network may configure the WTRU for multi-TRP ST×MP operation, for example after (e.g., upon) receiving a WTRU capabilities report. The network may configure the WTRU for multi-TRP ST×MP operation by splitting the SRI and SRS sets, for example based on the (e.g., described) panel grouping and/or Pg power sharing capabilities. The panel grouping and/or Pg power sharing capabilities may allow the scheduler to determine (e.g., have a clear understanding of) the Pcmax calculation, PHR, and/or power sharing/scaling.

The Pg,max parameter be dynamic (e.g., variable), for example due to WTRU panel physical antenna/panel layout. It may be beneficial for the network to know how the power calculation and sharing may change, for example based on one or more of beam measurements reports, beam failure recovery and/or new beam serving Pg, max and/or Pg, and/or max power sharing parameters.

Power control change procedures may be performed, for example for a beam change in the panel grouping (Pg) context. The WTRU may determine (e.g., compute) Pcmax for each active beam direction. For example the WTRU may determine (e.g., compute) Pcmax for each active beam direction differently. Determination of Pcmax for each active beam direction may be based on the WTRU capabilities for multi-TRP ST×MP scenario, for example related to the panel grouping and power sharing. The WTRU may signal/give feedback on the status of the Pg,max and/or related Pg,max parameters for the new beams, for example when the conditions for a serving beam change due to a beam failure or a beam change (e.g., TCI indication based).

The WTRU may provide feedback for Pg,max parameters. The WTRU may trigger a PHR report. The PHR report may include the (e.g., new) Pg, max power sharing status for the (e.g., new) beams. For example, the WTRU may indicate the new Pg,max Power Sharing status for a new beam in the first PHR report for the new active beam. A change in Pg,max power sharing for a beam may trigger a PHR report, for example with the new Pg,max power sharing status. Whether a change in Pg,max triggers a PHR report may be subject to, for example a configurable threshold. For example, if the change in Pg,max power sharing exceeds a configured value (e.g. Pgmax-threshold), the WTRU may trigger PHR reporting with the new Pg,max power sharing status.

There may be (e.g., two) beams that may have their own Pcmax,beam,i definition, and therefore, for example, the PHR may be enhanced for the intra-cell multi-TRP. There may be a single cell (e.g., one PCI and its related SSBs and a secondary TRP without SSBs). The single entry PHR report may be enhanced for the support of (e.g., two) beams related Pcmax and/or PH (power headroom).

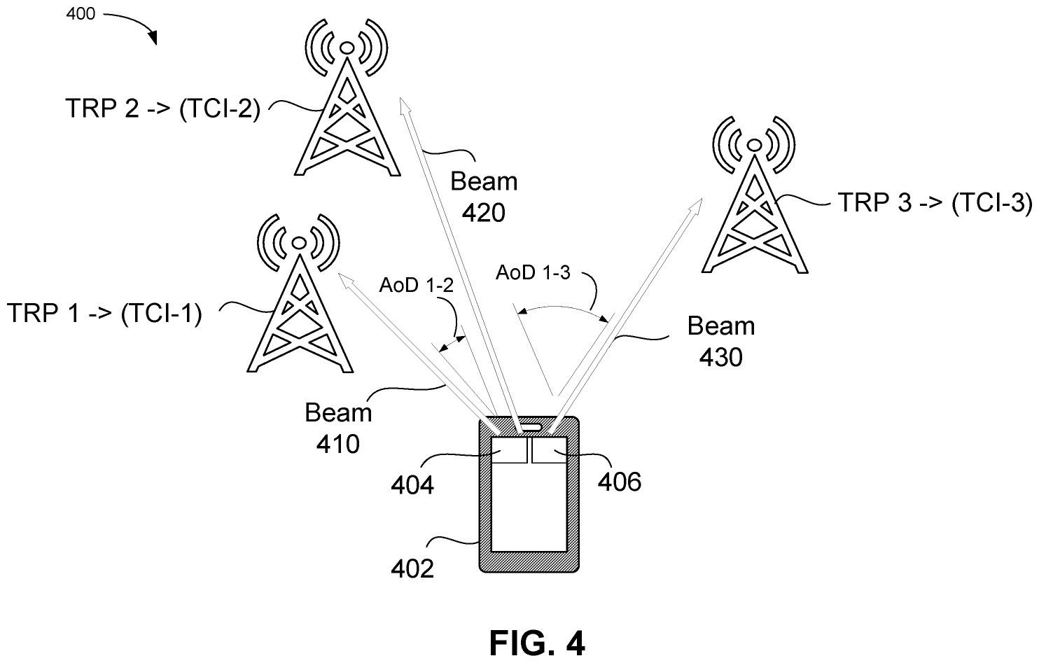

FIG. 4 is a diagram illustrating another example scenario 400 of beams (e.g., such as beams 410, 420, 430) served by 2 panel groups. One or more of beam 410, beam 420, and beam 430 may be served by one or more of 2 panel groups 404, 406. The WTRU 402 may transmit (e.g., declare) the WTRU ST×MP capabilities, for example to a gNB. The ST×MP capabilities may include panel group 404 including a full power panel group and/or panel group 406 including a full power panel group. The WTRU 402 may receive an indication to transmit simultaneously. Alternatively, or additionally, the WTRU 402 may determine to transmit simultaneously. The indication may be to transmit to TRP1 (e.g., beam 1: TCI-1) and TRP 2 (e.g., beam 2: TCI-2) simultaneously. Simultaneous transmission may include transmission of beam 410 and/or beam 420. For example, beam 410 may be transmitted to TRP 1 (e.g., TCI-1) and/or beam 420 may be transmitted to TRP 2 (e.g., TCI-2). Simultaneous transmissions may overlap in the time domain. For example, simultaneous transmissions may be transmissions that overlap in time, transmissions that partially overlap in time, and/or slightly offset transmissions, for example, due to timing advances. The WTRU may transmit a PHR (e.g., one or more triggers), for example with Pcmax,1 for TCI-1 and/or Pcmax,2 for TCI-2. A power sharing bit may be set to True, for example based on using beam 410 and/or beam 420 for transmissions (e.g., based on panel group 1 serving beam 1, beam 2, and/or an angle between the beams AoD 1-2). The WTRU 402 may receive an indication to transmit simultaneously to TRP 2 (e.g., beam 420: TCI-2) and TRP 3 (e.g., beam 430: TCI-3), for example if beam 410 is weak and/or fails. The WTRU 402 may transmit a PHR (e.g., based on the one or more triggers), for example with Pcmax,2 for TCI-2 and/or Pcmax,3 for TCI-3. A power sharing bit may be set to False, for example based on/since the WTRU is capable of full power and/or maximum EIRP per beam.

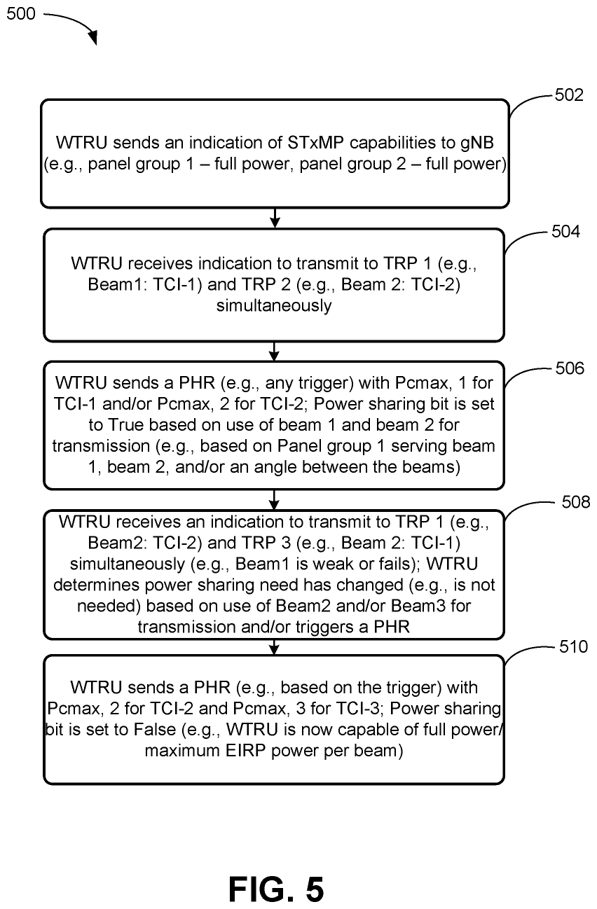

FIG. 5 is a flowchart of an example process 500. At 502 a WTRU may send an indication of ST×MP capabilities to a gNB. The capabilities may include panel group 1—full power and/or panel group 2—full power). At 504 the WTRU may receive an indication to transmit to TRP1 (e.g., beam 1: TCI-1) and TRP 2 (e.g., beam 2: TCI-2) simultaneously. At 506 the WTRU may send a PHR (e.g., any trigger) with Pcmax, 1 for TCI-1 and/or Pcmax, 2 for TCI-2. A power sharing bit may be set to true, for example based on the use of beam 1 and beam 2 for transmission (e.g., based on panel group 1 serving beam 1, beam 2, and/or an angle between the beams). At 508 the WTRU may receive an indication to transmit to TRP 1 (e.g., beam 2: TCI-2) and TRP 3 (e.g., beam 2: TCI-1) simultaneously. The WTRU may determine that a power sharing need has changed (e.g., is not needed), for example based on use of beam 2 and/or beam 3 for transmission and/or trigger a PHR. At 510 the WTRU may send a PHR (e.g., based on the trigger), for example with Pcmax, 2 for TCI-2 and Pcmax, 3 for TCI-3. A power sharing bit may be set to false (e.g., WTRU is now capable of full power/maximum EIRP power per beam).

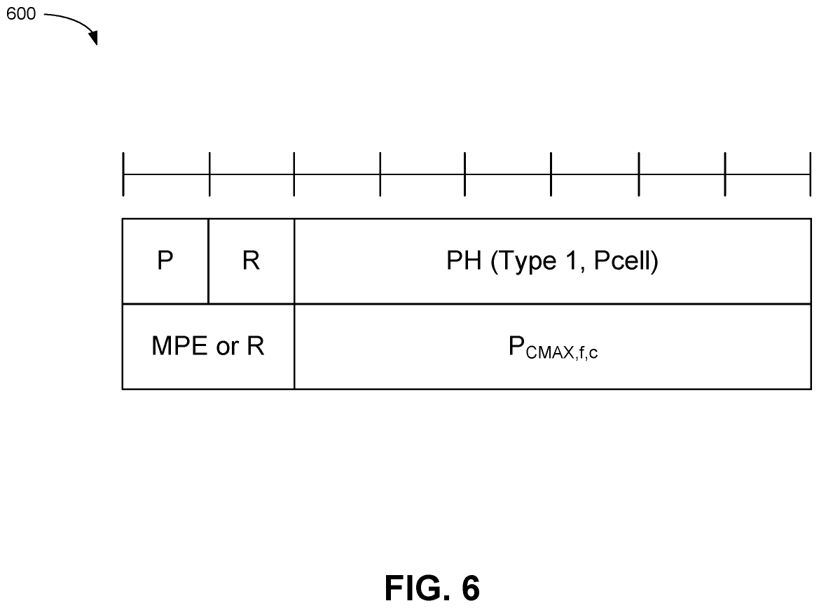

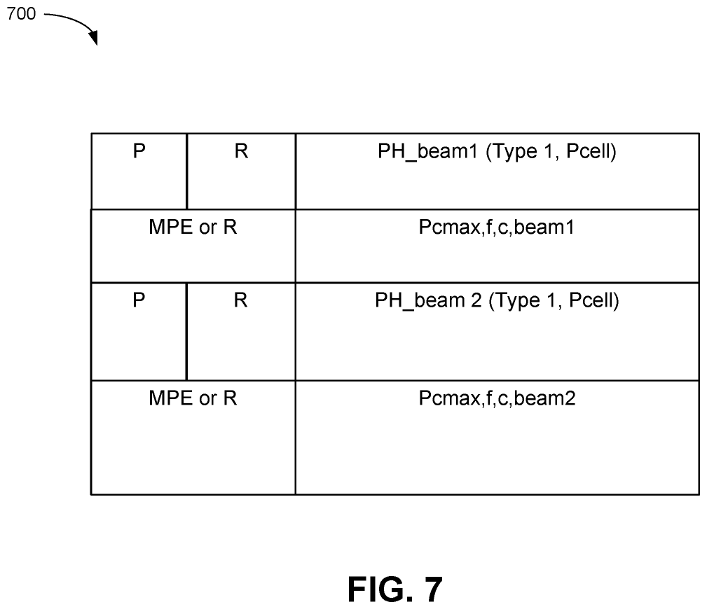

FIG. 6 is a diagram illustrating an example 600 of a single entry PHR. FIG. 7 is a diagram illustrating an example 700 of an extended PHR version. The network may support an extended PHR version, for example if there are two TRPs in a multi-TRP configuration capable of ST×MP operation. As shown in FIG. 7, R may be a reserved bit, for example that may be set to 0. Maximum permitted exposure (MPE) is also shown.

The reserved bit may be used to signal the Pg,max power sharing status. The use and re-interpretation of the reserved bit as Pg,max power sharing status (e.g., True or False) and/or the format of the extended MAC CE may be conditioned by the configuration of the WTRU, for example, in a multi-TRP operation with ST×MP. The R bit may indicate the panel group power sharing status, for example associated with the WTRU power class capability per beam.

The multi-TRP operation may be intra-cell or inter-cell, and/or the WTRU may send the PHR report to both cells in case of inter-cell case and only to pTRP (e.g., anchor TRP), for example in case of intra-cell configuration. The report may be sent on the current received grant and/or at the first valid UL grant for the beam with the power status change, for example if the network or WTRU triggers a PHR report for the Pg,max power sharing status and/or the WTRU is configured for multi-TRP inter-cell, and/or there is only one valid UL grant. The report may be sent on the current received grant, for example, (e.g., only) if the trigger is for the beam with the power sharing status change and/or allocated grant. The report may be sent (e.g., only) at the first valid UL grant for the beam with the power status change, for example if the trigger is not for the beam with the power sharing status change and/or allocated grant. A WTRU may be configured with two separate PHR prohibit timers (e.g. a prohibit timer is configured and maintained per cell), for example if a WTRU is configured with multi-TRP inter-cell operation. The WTRU may report the PHR on the cell where the prohibit timer may not be currently running, for example if the network and/or WTRU triggers a PHR report for the Pg,max power sharing status and/or the WTRU is configured for multi-TRP inter-cell, and/or if a prohibit timer is running for one cell. The WTRU may wait until the prohibit timer expires and/or transmit the PHR report on the next suitable UL grant (e.g., after expiry of the prohibit timer), for example, regardless of the status of a prohibit timer on the other cell. The WTRU may transmit the PHR report on the next suitable UL grant on the cell in which the prohibit timer may expire first, for example if both prohibit timers are running. WTRU actions and/or processes as herein may be based on one or more of configuration(s), the contents of the PHR report, the trigger which caused the PHR report, and/or characteristics of the cell (e.g. whether one cell is a primary cell).

A WTRU may adapt periodic PHR reporting (e.g. via modification to operation of the phr-periodic timer), for example to avoid excessive PHR reporting. The WTRU may adapt periodic PHR reporting if a WTRU is configured with multi-TRP inter-cell operation. A WTRU may extend the periodicity of periodic reporting (e.g. via application of a scaling factor and/or by setting timer duration to an alternate value), for example if a WTRU is configured with multi-TRP inter-cell operation. The WTRU may (e.g., upon expiration of the periodic timer) trigger a PHR report to both cells, for example if a WTRU is configured with multi-TRP inter-cell operation. A WTRU may (e.g., independently) configure periodic reporting per cell. Periodicities and/or timer maintenance may be (e.g., independently) configured and/or handled per cell. Upon expiration of one periodic timer for example, a WTRU may report PHR to the cell corresponding to the timer which expired. Functionality for one cell may trigger PHR reporting to, for example, one cell (e.g. the cell in which was configured or reconfigured) or both cells. For example, if a WTRU is configured with multi-TRP inter-cell operation, upon configuration or reconfiguration of power headroom reporting, functionality for one cell may trigger PHR reporting to, for example, one cell (e.g. the cell in which was configured or reconfigured) or both cells. A WTRU may cancel all triggered PHRs (e.g., only) once the PHR has been (e.g. successfully) transmitted on both cells, for example if a WTRU is configured with multi-TRP inter-cell operation. The WTRU may cancel (e.g., all) remaining PHR reports triggered for the same cell (e.g., triggered PHRs for the other cell may not be cancelled), for example upon transmission of a PHR on one cell.

Aperiodic PHR may be ordered by a network. The network may (e.g., alternatively or additionally) trigger/order an aperiodic PHR report upon one or more of a TCI activation, beam failure recovery, and/or beam change. The aperiodic PHR may include the panel group power sharing status bits, for example for a specific beam that may be determined by the type or aperiodic PHR order. The WTRU may report (e.g., only) for that specific beam and/or TCI, for example if a DCI is received in the specific beam designated coreset or coreset pool. Alternatively, or additionally, the WTRU may report the PHR for (e.g., both) UL beams based on any DCI order received on any related beam. The network may order an aperiodic PHR report using DCI, MAC CE orders, and/or using specific triggers, for example along with an RRC configuration as described herein.

The WTRU may be configured with multi-TRP related PHR format, for example at the RRC level. The PHR may be triggered based on one or more of beam change, beam activation, serving panel group status change, and/or TCI activation. The PHR may be sent based on one or more of upon receiving a dual UL simultaneous grant for both beams/TCIs, and/or upon receiving a first UL grant for any active beam.

A network ordered aperiodic PHR report may provide resources. The resources may be used to transmit the PHR report. The MAC CE may contain an UL grant for transmission of the requested PHR, for example if the aperiodic PHR report was triggered via MAC CE. The aperiodic PHR report may indicate the PHR format to use, and/or whether to report the PHR on one cell or both cells (e.g. in the case of multi-TRP inter-cell operation).

A panel group power sharing status may form at least part of a (e.g., new) report. The panel group power sharing status may include a (e.g., new) report that, for example may be triggered like PHR, and/or may have a (e.g., partially or completely) different format. Additionally, or alternatively, the panel group power sharing status may be attached/included (e.g., piggybacked) with a panel measurement related message. The panel group power sharing status may be added in one or more beam measurement reports, for example in the RRM measurements with L3 filtering. The panel group power sharing status may be a (e.g., new) MAC CE report that, for example may contain the active beams Pg,max power sharing status. Additionally, or alternatively, the report may contain (e.g., all) the measured beams related to a Pg,max power sharing status. The panel group power sharing may be included with (e.g., within) the RRM measurement report or not included with (e.g., within) the RRM measurement report based on configuration. The WTRU may include one or more beam measurement reports (e.g., based on the event which triggered the RRM measurement report). The panel group power sharing may be included in (e.g., only) for event-triggered RRM reports and/or periodic reports. One or more new RRM reports may be defined, wherein upon satisfaction of the event the WTRU may send an RRM report, for example including panel group power sharing. The power group panel sharing level may change a fixed amount from the previously reported power group panel sharing level. The WTRU may indicate the Pg max power sharing status in the L1-RSRP reports, for example in the CSI. The priority of a measurement for a beam may one or more of include a changed power sharing change, be newly reported, and/or be higher than a regular L1-RSRP report (e.g., may be without a Pg max power sharing status change), for example if the CSI reports have priorities assigned.

The panel index parameter may be re-interpreted in CSI beam reporting, for example for Pg indication. The WTRU may include (e.g., attach) in the (e.g., usual) beam measurement report(s) (e.g., L1 beam, and/or CSI, reporting) one or more reports. The one or more reports may include one or more of quantity parameters and/or values based on at least one of a preferred panel index (e.g., and/or corresponding WTRU-capability index related to antenna group and/or WTRU-panel); a preferred beam index; a beam strength/quality metric (e.g., L1-RSRP, L1-SINR); the Pg, the beam serving Max Pg (Pg,max); and/or the Pg,max power sharing potential status. The WTRU may report the panel index along with the beam measurement, for example in CSI reports. Signaling may be re-interpreted and/or enhanced and/or modified based on panel grouping (e.g. rather than the panel), for example while maintaining a backward compatibility. Additionally, or alternatively, the panel grouping may include a Pg and/or Pg serving a beam and/or the signaling may be re-interpreted (or enhanced or modified) based on panel grouping.

The WTRU may report the beam measurements with an interpretation as herein. For example, if the WTRU capability indicates Pg,max=1 then the interpretation of the panel index may stay as is and/or may be a panel index and/or a single panel group serving per beam. The WTRU may report one or more of a preferred panel index set to 0, a preferred beam index 3 (e.g., associated with the panel index=0), and/or a value of the beam strength/quality metric, for example in a (e.g., L1) beam and/or CSI reporting instance. The reported panel index of 0 may be interpreted as the WTRU's preferred panel selection for panel index 0 among a plurality of panel indexes (e.g., based on WTRU capability, e.g., corresponding WTRU-capability index related to antenna group and/or WTRU-panel). The WTRU may report one or more of a preferred panel index set to 1, a preferred beam index 5 (e.g., associated with the panel index=1), and/or a value of the beam strength/quality metric, for example in a (e.g., L1) beam and/or CSI reporting instance. The reported panel index of 1 may be interpreted as the WTRU's preferred panel selection for panel index 1 among the plurality of panel indexes.

The WTRU may report the beam measurements, for example upon configuration for multi-TRP ST×MP operation. For example if the WTRU capability indicates Pg,max>1 then the interpretation of the panel index may be panel grouping based on WTRU capability, and/or this indication may be embedded with the Pg,max power sharing status (e.g., a bit may be required). The WTRU may receive a configuration and/or indication for how each panel index, for example to be used for (e.g., L1) beam and/or CSI reporting, may be re-interpreted (e.g., associated and/or mapped) for delivering the panel grouping related information (e.g., not a single panel selection). A panel index may be re-interpreted as a panel group index. The panel group index may be configured and/or indicated to point to one or more panel indexes (e.g. as a combination). The WTRU may receive a dynamic indication (e.g., via a MAC-CE and/or a DCI) of a mapping between a panel group index and the one or more panel indexes (e.g., as the combination). The panel index 0 (e.g., to be used for (L1) beam and/or CSI reporting) may be re-interpreted (e.g., in case of Pg,max>1) as a panel group index 0 which, for example may indicate a combination of panel index 0 and panel index 1. The panel index 1 (e.g., to be used for (L1) beam and/or CSI reporting) may be re-interpreted (e.g., in case of Pg,max>1) as a panel group index 1 which, for example may indicate a combination of panel index 1 and panel index 2.

A parameter of Pg,max may be reported in the (e.g., L1) beam and/or CSI reporting. The Pg,max parameter may have a dynamic nature, for example due to WTRU panel physical antenna/panel layout. The WTRU may apply the re-interpretation of the panel index (e.g., to a panel group index), for example when the WTRU reports the parameter of Pg,max set to be more than one. The WTRU may be configured and/or indicated to report the parameter of Pg,max power sharing in the (e.g., L1) beam and/or CSI reporting.

The network may control panel groups assignments. The network may configure the WTRU panel groups by assigning them to a (e.g., specific) TCI or group of TCIs, for example upon receiving the WTRU capability report and/or (e.g., subsequent) beam related measurements. The TCIs may be configured by RRC to (e.g., specific) WTRU declared panel groups. The WTRU declared panel groups may satisfy a power capability criterion (e.g., power sharing or not) and/or may be based on the measurement reports that, for example may have an embedded indication of the serving panel group(s) used for measurements.

When the panel groups are semi-statically assigned to the configured TCIs and/or when a TCI is activated by a MAC CE order for example, the corresponding panel group(s) may be activated (e.g., as well). There may be an activation delay before the first transmission may take place, for example if the panel group is activated for the first time. For example, there may be a scheduling delay. The scheduling ready state of a panel group may be signaled by the ACK to the TCI activation and/or a supplementary fixed time delay after the TCI activation acknowledgement. The delay may be counted in several symbols and/or slots. The panel group ready scheduling status may be considered, for example after the delay.

MPR application rules may be followed. The WTRU capability for multi-TRP ST×MP with mDCI may include 2 or more independent UL grants, for example in the context of panel grouping. The UL grants may have different configurations in frequency domain and/or may overlap in time domain. In an example, the gNB may need to know how the MPR has been derived, for example, based on the panel grouping and panel grouping power sharing status parameters. The WTRU may apply different rules for MPR derivation and/or Pcmax value and/or range validation, for example when the UL grants overlap in time. The power sharing parameter may be indicated by the WTRU and/or to the WTRU by network (e.g., when selecting the TCI/beam/serving panel group), which may for example be used to determine (e.g., eventually decide) a rule for MPR determination. Additionally, or alternatively, the panel group power sharing status parameters may include an WTRU internal status. The power sharing status parameters may be related to the WTRU antenna panel layout and/or grouping, for example without (e.g., any) network knowledge. The MPR determination rules may be related to the panel group(s) power sharing.

The WTRU may use the selected panel group(s) Pg,max power sharing status to derive the related MPRg_{,f,c} and/or ΔMPRg, for example per beam. The Pg,max power sharing status may be known by the WTRU, for example from declared WTRU capabilities and/or it may be an internal status variable based on antenna hardware design (e.g., not known by network).

The Pg,max power sharing status as described herein may assist (e.g., serve) in WTRU decision-making for the MPR rules derivation. The WTRU may use (e.g., the following) equations as herein for Pcmax value and/or range validation, for example when the WTRU receives in mDCI mode two simultaneous UL grants that are each characterized by RB allocation and modulation order, and/or the UL transmissions are overlapping in time domain. For example for Pcmax per beam validation, the configured WTRU maximum output power P_{CMAX,f,c, beam,i} for carrier f of a serving cell c may be set such that the corresponding measured peak EIRP P_{UMAX,f,c, beam,i} for each transmitting beam may be within the following bounds: P_{Powerclass}+DP_{IBE}−MAX(MAX(MPRg_{,f,c}+ΔMPRg, A-MPR_{f,c,})+ΔMB_{P,n}, P-MPR_{f,c})−MAX{T(MAX(MPR_{f,c}, A-MPR_{f,c,})), T(P-MPR_{f,c})}P_{UMAX,f,c, beam,i}≤EIRPmax, and/or per WTRU when both beams are transmitting: P_{TMAx,f,c}≤TRPₘₐₓ.

When (e.g. only) one beam is transmitting for example, the MPRg_{,f,c} may be MPR for a single beam and/or ΔMPR may be 0 (e.g., the WTRU may fall back to a single UL transmission). The WTRU may determine to use (e.g., evaluate to) simultaneous UL transmission RB allocations within the channel bandwidth and/or may determine (e.g., decide) the beam based power reductions MPRg_{,f,c} and ΔMPRg, for example based on the RB allocation topology and/or modulation order. The WTRU may determine the actual P_{CMAX,f,c, beam,i.}, for example after determining the appropriate reductions. The P_{CMAX,f,c, beam,i} value for each beam may be used (e.g., afterward) as a limit in the power allocation equations, for example from the physical layer for each beam respectively (e.g., as the RF compliance being resolved by Pcmax equations). For PUSCH the equation may be:

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

For PUCCH the equation may be:

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

In equations described herein (e.g., in both equations above), Pcmax,f,c (i) may be equal to P_{CMAX,f,c, beam,j} in slot i and beam j, respectively.

If there is a power limitation (e.g., if the above equations lead to a power limitation), for example capped by P_{CMAX,f,c, beam,j}, (e.g., then) the related power of the channel in cause (e.g., PUSCH and/or PUCCH) for a beam may be scaled down to the compliant P_{CMAX,f,c, beam,j} level. The WTRU may transmit the UL channels at a predetermined timing (e.g., the right timing) per beam, for example after allocating the power and any possible scaling operation. In MPR determination rules as herein the Pg,max power sharing status bit may be used for WTRU decision making and/or may be an WTRU internal algorithm binary variable, for example after allocating the power and any possible scaling operation.

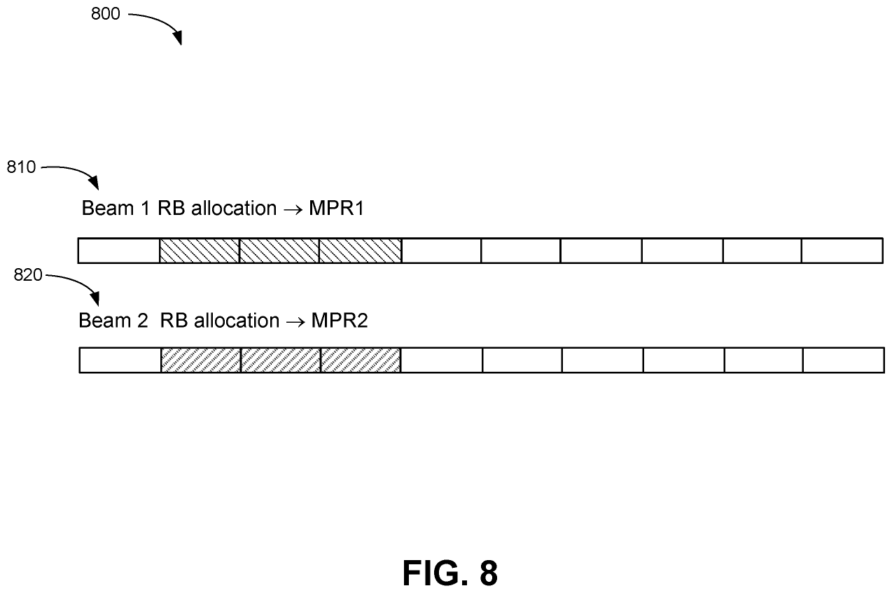

FIG. 8 is a diagram showing an example of perfect overlapping RB allocations 800 in frequency domain. There may be perfect overlapping RB allocations in frequency domain. For example, Beam1 RB allocation may be MPR1 at 810, and/or Beam2 RB allocation may be MPR2 at 820. Possible rules may be described herein. The Pg, max power sharing status bit may indicate a power sharing status, for example for a (e.g., respective) set of (e.g., two or more) beams. For example, if the Pg,max power sharing status bit is false, and/or the modulation order is the same, then MPR1=MPR2 and/or the Pcmax,beam,i may be computed independently per Pg. If the Pg,max power sharing status bit is true, and/or the modulation order is the same, for example, then MPRg=MPR1=MPR2 and/or the Pcmax,beam,i may be computed independently using MPR1, and/or (e.g., then) an additional Delta ΔMPRg=3 dB reduction may be applied to each Pcmax,beam,i. Additionally, or alternatively, ΔMPRg may include (e.g., be) a specific quantity in dB, for example determined by WTRU calibration. For example, ΔMPRg=1.5 dB and/or may be different than 3 dB (e.g., which may be an exemplary quantity).

If, for example, the Pg,max power sharing status bit is false, and/or the modulation order is different, (e.g., then) MPR1 and MPR2 may be different and/or the Pcmax,beam,i may be computed independently. If, for example, the Pg,max power sharing status bit is true, and/or the modulation order is different, then MPR1 and MPR2 may be different and/or the Pcmax,beam,i may be computed independently using MPRg, and/or (e.g., then) an additional ΔMPRg=3 dB reduction may be applied to each Pcmax,beam,i. Additionally, or alternatively, ΔMPRg may be a specific quantity in dB, which for example may be determined by WTRU calibration (e.g., depending on the modulations on these beam transmissions). The MPRg may be computed as MPRg=max {MPR1, MPR2}.

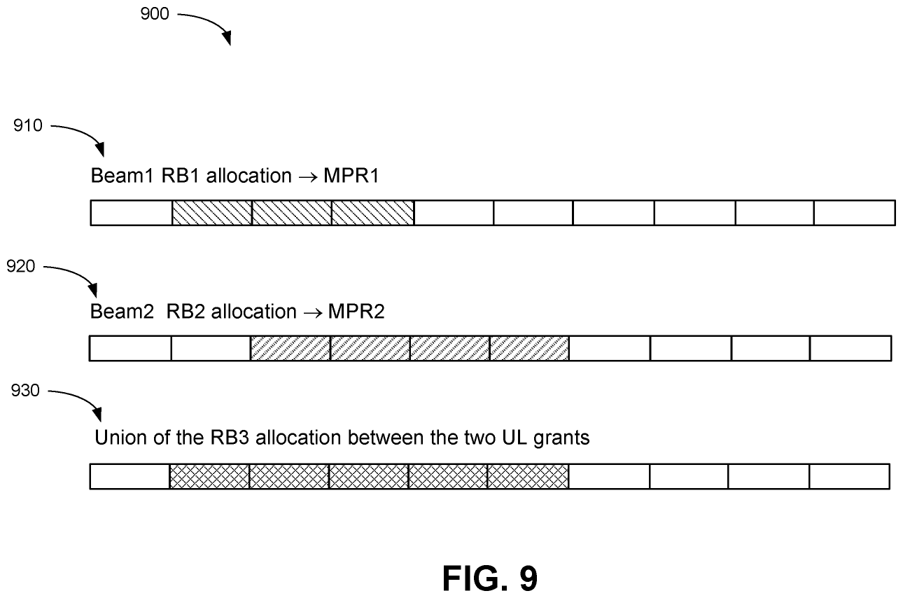

FIG. 9 is a diagram showing an example of overlapping RB allocations 900 RB allocations with different sizes in frequency domain. RBs may be perfectly overlapping. There may be overlapping RB allocations with different sizes in the frequency domain. For example, FIG. 9 shows a Beam1 RB1 allocation 910 for MPR1, a Beam2 RB2 allocation 920 for MPR2, and a combination (e.g., union) 930 of the RB3 allocation between the two UL grants. There may be (e.g., several possible) rules for MPR application. If the Pg,max power sharing status bit is false, and the modulation order is the same for example, then MPRg=MPR1=MPR2 and the Pcmax,beam,i may be computed independently per Pg. (e.g., based on MPRg and ΔMPRg=0). If the Pg,max power sharing status bit is true, and/or the modulation order is the same for example, (e.g., then) MPRg=MPR1=MPR2 and/or the Pcmax,beam,i may be computed independently per Pg (e.g., based on MPRg). ΔMPRg may be applied to each Pcmax, beam,l based on the following equation: ΔMPRg=3 dB+10 log [RB_new], for example due to the overlapping part a possible extra power reduction. RB_new may be determined as a function of RB1, RB2, and/or RB3. One or more of RB_new=max (RB1/RB3, RB2/RB3), RB_new=max (RB1, RB2, RB3), and/or RB_new=union of RB1 and RB2 may apply.

The function for RB_new may be determined based on one or more of one or more system parameters, one or more beam-specific parameters, one or more scheduling parameters, and/or a WTRU power class. The function for RB_new may be determined based on one or more system parameters (e.g., subcarrier spacing, and/or CP length). A first function (e.g., RB_new=max (RB1/RB3, RB2/RB3)) to determine RB_new may be used, for example if subcarrier spacing is less than a threshold. A second function (e.g., RB_new=RB3) to determine RB_new may be used, for example if the subcarrier spacing is not less than a threshold (e.g., greater than or equal to). In an example, the function for RB_new may be determined based on one or more beam-specific parameters. Beam-specific parameters may include one or more of a TA value, a TA difference between two beams, and/or a power allocation of each beam. A first function (e.g., RB_new=max (RB1/RB3, RB2/RB3)) to determine RB_new may be used, for example if TA difference between two beams is less than a threshold. A second function (e.g., RB_new=RB3) to determine RB_new may be used, for example if TA difference between two beams is not less than a threshold (e.g., greater than or equal to). The function for RB_new may be determined based on one or more scheduling parameters. Scheduling parameters may include one or more of, MCS for each beam and/or a number of RBs allocated for each beam. A first function (e.g., RB_new=max (RB1/RB3, RB2/RB3)) to determine RB_new may be used, for example if the number of RBs allocated for any of the beams is larger than a threshold. A second function (e.g., RB_new=RB3) to determine RB_new may be used, for example if the number of RBs allocated for any of the beams is not larger than a threshold (e.g., less than or equal to). The function for RB_new may be determined based on WTRU power class. A first function to determine RB_new may be used, for example when a WTRU is capable of a first WTRU power class. A second function to determine RB_new may be used, for example when a WTRU is capable of a second WTRU power class.

Additionally, or alternatively, a rule may include a consideration of the overlapping RB allocation against the union RB3: ΔMPRg=3 dB+10 log [max (RB3-RB1, RB3-RB2)/RB3]. ΔMPRg may be a factor, for example, empirically determined from calibration/measurements and/or interpolation. For example, if the Pg,max power sharing status bit is false, and/or the modulation order different, (e.g., then) MPR1 and MPR2 may be different and/or the Pcmax,beam,i may be computed independently per Pg. based on MPRg,i, i=1,2 and ΔMPRg=0. For example, if the Pg,max power sharing status bit is true, and/or the modulation order is different, (e.g., then) MPR1 and MPR2 may be different and/or the Pcmax,beam,i may be computed independently using MPRg, and/or (e.g., then) an additional MPRg reduction may be applied to each Pcmax,beam,i (e.g., based on the equation: MPRg=max {MPR1, MPR2}, ΔMPRg=3 dB+10 log [max (RB1/RB3, RB2/RB3)]). Additionally, or alternatively, ΔMPRg may be a factor, for example empirically determined from calibration measurements and interpolation.

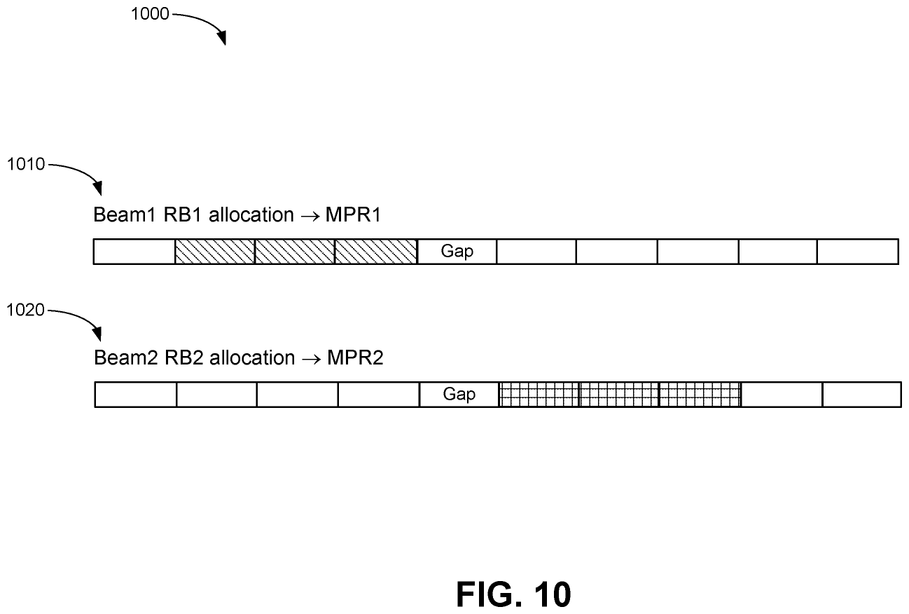

FIG. 10 is a diagram showing an example of non-overlapping RB allocations 1000 in a frequency domain. The non-overlapping RB allocations 1000 in frequency domain may include a Beam 1 RB1 allocation 1010 for MPR1 and a Beam 2 RB2 allocation 1020 for MPR2. The non-overlapping RB allocations 1000, which may, for example, include a non-contiguous allocation between RB1 and RB2. The gap between RB1 and RB2 may be fixed, known by the WTRU and/or network for example. The gap between RB1 and RB2 may be fixed and/or known due to a possible coexistence mitigation requirement. The fixed gap in the frequency domain between RB1 and RB2 allocation may be a minimum requirement. For example, if the gap is known/specified, and/or the UL grants for the simultaneous transmissions respect the minimum gap, the WTRU may consider the Pg,max power sharing status bit as false. For example, if the gap is not known/specified, and/or the UL grants for the simultaneous transmissions do not respect the minimum gap, the WTRU may consider the Pg,max power sharing status bit as true.

Additionally, or alternatively, the WTRU may consider its own panel grouping and/or physical layout for Pg,max power sharing status decisions, for example regardless of the RB allocations frequency domain gap. For example, as shown in FIG. 10, Beam1 RB1 allocation 1010 may be for MPR1, and Beam2 RB2 allocation 1020 may be for MPR2. If the Pg,max power sharing status bit is false, and/or the modulation order is the same or different, then MPR1 and MPR2 may be different and/or the Pcmax,beam,i may be computed independently per Pg, for example, based on MPRg,i, i=1,2 and/or ΔMPRg=0. If the Pg,max power sharing status bit is true, and/or the modulation order is different or the same, then MPR1 and MPR2 may be different and/or the Pcmax,beam,i may be computed independently. Pcmax,beam,i may be computed using MPR1 and MPR2 when MPR1 and MPR2 are different. Pcmax,beam,i may be computed using MPRg when MPR1 and MPR2 are equal. An additional ΔMPRg reduction may be applied (e.g., following one or more rules as herein). For example, MPRg=may follow the rules for non-contiguous allocations in a NR carrier when the modulation order is the same on both UL grants. Additionally, or alternatively, when the MPR1 and MPR2 are different: MPRg=max (MPR1, MPR2).

The supplementary reduction ΔMPRg may be applied and/or may be (e.g., empirically) determined based on measurements/calibrations and/or interpolation for the allocation, for example considering MPRg=max (MPR1, MPR2) for MPR related modulation order. ΔMPRg may be 0 and, (e.g., only) the non-contiguous allocation for the MPRg=max (MPR1, MPR2) corresponding to the highest modulation order may be computed.

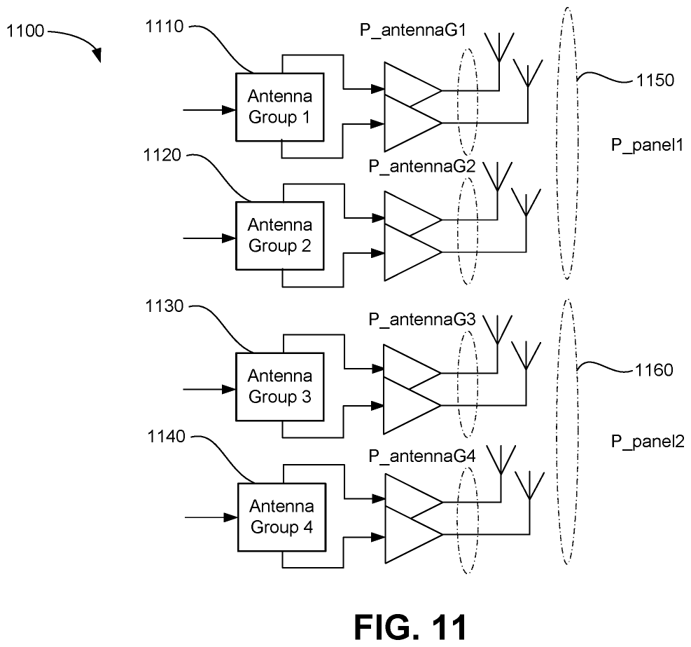

FIG. 11 shows an example implementation of a multi-panel WTRU 1100 where, for example each of one or more panels (e.g., such as panels 1150, 1160) may be built using more than one antenna group. An inter-panel power switch may be used. In an example, the WTRU 1000 may employ one or more panels 1150, 1160 where each of the panels 1150, 1160 may include one or more antenna groups 1110, 1120, 1130, 1140. For example, a first panel 1150 (e.g., P_panel1) may include antenna groups 1110, 1120 and a second panel 1160 (e.g., P_panel2) may include antenna groups 1130, 1140. The power rating per panel and/or per antenna group may be different, for example depending on WTRU implementation. The power rating of power amplifiers in different transmitter chains may not be equal and/or (e.g., therefore) the power rating per antenna group and per panel may be different. A multi-panel WTRU 1100 with multiple antenna groups per panel is shown. A WTRU 1100 with two panels for example, may have a power rating of P_panel1 where P_panel1≤P_panel2. There may be different power rating for each antenna group, if a panel is comprised of two antenna groups.

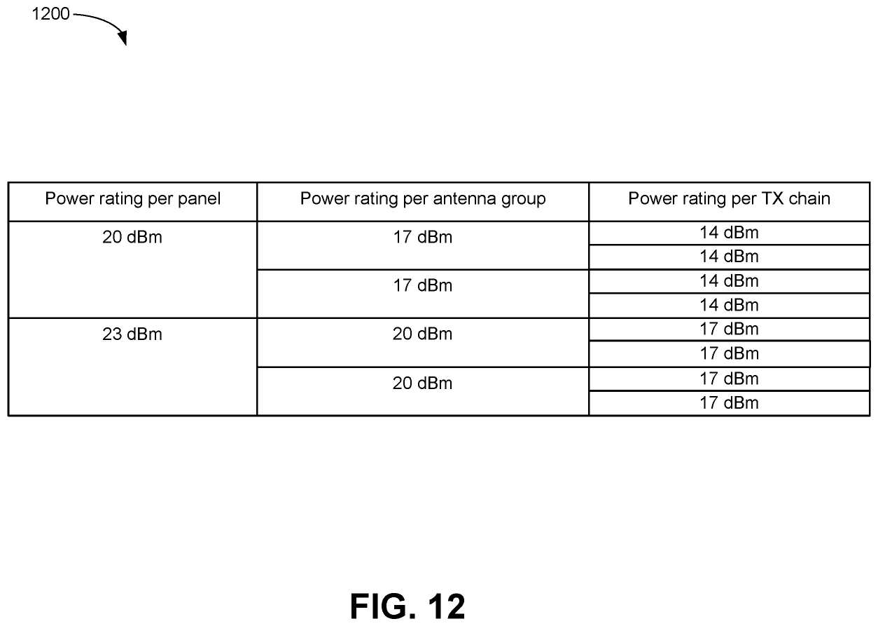

FIG. 12 is an example table 1200 depicting a set of power rating per panel, per antenna group. For example, as shown in Table 1, P_antennaG1=P_antennaG2, P_antennaG3=P_antennaG4, and/or P_antennaG1+P_antennaG2<P_antennaG3+P_antennaG4. A WTRU may employ an RF switch network that, for example may allow switching of the output of one or more of its power amplifiers between more than one antenna group and/or panel.

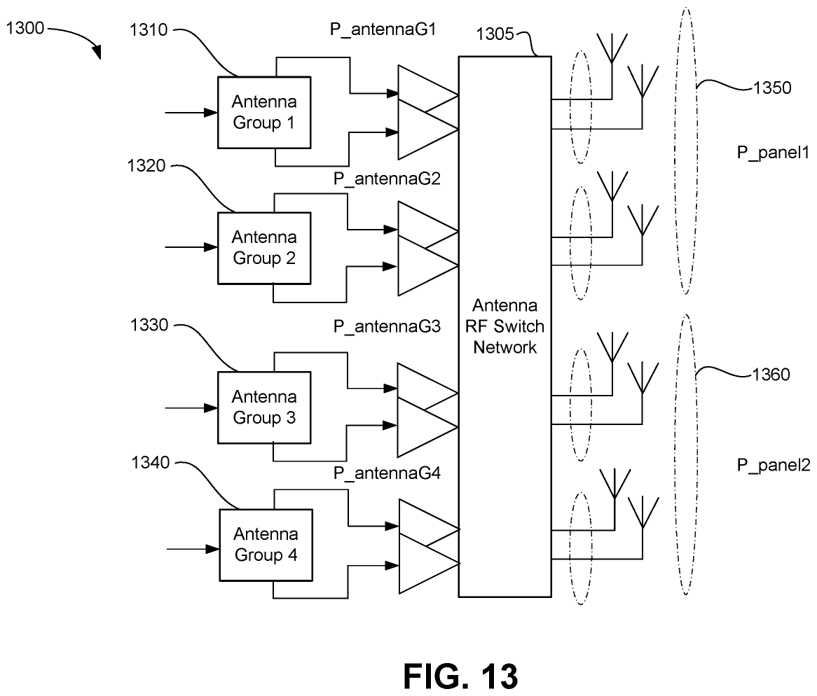

FIG. 13 is a diagram illustrating an example of a multi-panel WTRU 1300 with antenna switch capability. The antenna switch network 1305 may connect the output of the power amplifiers to different antenna groups and/or panels. A WTRU 1300 may assign more power to the panel 1350, 1360 that may request and/or require more power (e.g., for a reliable transmission), for example if a WTRU 1300 has such capability. A multi-panel WTRU 1300 with one or more antenna groups 1310, 1320, 1330, 1340 may indicate one or more capabilities. Capabilities may include one or more of power rating per panel, power rating per antenna group 1310, 1320, 1330, 1340, and/or an indication. An indication may an indication thay one panel may have a higher power rating than other panel(s). The indication may include an indication that one antenna group 1310, 1320, 1330, 1340 may have a higher power rating than the other antenna group(s) 1310, 1320, 1330, 1340. The indication may include information related to the power difference (e.g., +3 dB) and/or an indication whether the panels and/or antennas may be switched from one set of power amplifiers to another.

A multi-panel WTRU 1300 may indicate its power rating capability per antenna group 1310, 1320, 1330, 1340 and/or panel 1350, 1360. The WTRU 1300 may indicate its antenna switch capability, for example for allocating more or less power to a panel and/or antenna group 1310, 1320, 1330, 1340 (e.g., if needed). For example in a multi-TRP scenario, the WTRU 1300 may perform one or more of initiating an initial transmission, and/or selecting an initial RF switch state (e.g., based on some basic measurements upon completion of the indication of power and switching capability). For example, a WTRU 1300 may select its initial RF switch state based on some basic measurements. A WTRU 1300 may select its RF switch state based on some other configured measurements, for example once in the connected mode. A WTRU 1300 may receive an implicit or an explicit indication to switch a panel to a particular RF chain. A WTRU 1300 may receive an (e.g., explicit) indication in a DCI and/or a MAC CE, for example to switch a panel to a particular RF chain. A WTRU 1300 may receive an (e.g., explicit) indication in a DCI and/or a MAC CE, for example to switch a panel to a particular RF chain. A WTRU 1300 may identify the power capability for a panel according to the indicated MCS for a (e.g., each) codeword. For simultaneous PUSCH transmission on multiple panels, for example if a WTRU 1300 is indicated for transmission of two codewords, a WTRU 1300 may identify the power capability for a panel according to the indicated MCS for each codeword. A WTRU 1300 may identify the power capability for a panel according to the priority. For simultaneous PUSCH transmission on multiple panels, a WTRU 1300 may identify the power capability for a panel according to the priority. A WTRU 1300 may identify the power capability for a panel according to the existing priorities. For simultaneous PUSCH+PUCCH transmission on multiple panels, a WTRU 1300 may identify the power capability for a panel according to the existing priorities.

A WTRU 1300 may initiate its initial transmission (e.g., PRACH in an arbitrary RF switch state or a default mode in a multi-TRP scenario), for example upon completion of the indication of power and/or switching capability. The default switch state may be the panel associated with one of the TRPs, for example the serving TRP. A WTRU 1300 may select its initial RF switch state based on some basic measurements (e.g., an SSB measurement), for example in a multi-TRP scenario. A WTRU 1300 may select its RF switch state based on some other configured measurements (e.g., RSRP), for example in a multi-TRP scenario (e.g., once in the connected mode). A WTRU 1300 may perform RSRP measurements on a configured CSI-RS and/or switch the panel with a higher power capability, for example to the link that exhibits a lower RSRP measurement. A WTRU 1300 may receive an implicit and/or an explicit indication to switch a panel to a particular RF chain, for example in a multi-TRP scenario. A WTRU 1300 may receive an explicit indication in a DCI and/or a MAC CE to switch a panel to a particular RF chain, for example in a multi-TRP scenario. The indication may be a toggle command to toggle the power capability from the existing switch state to another. A WTRU 1300 may identify the power capability for a panel according to the indicated MCS for each codeword, for example in a multi-TRP scenario. Additionally, or alternatively, for simultaneous PUSCH transmission on multiple panels and/or if a WTRU 1200 is indicated for transmission of two codewords, a WTRU 1300 may identify the power capability for a panel according to the indicated MCS for each codeword. A WTRU 1300 may assign more power to the link associated with a lower MCS. The WTRU 1300 may identify the power capability for a panel according to the priority, for example in a multi-TRP scenario. The priority may be determined from the priority indication bit in the received DCI. Additionally, or alternatively, priority may be determined from a UL-SCH indicator as to whether PUSCH may contain data and/or UCI feedback. A WTRU 1300 may switch the panel with more power for its transmission, for example if a UL-SCH indicates a UCI carrying PUSCH. The WTRU 1300 may identify the power capability for a panel, for example according to one or more of the existing priorities. Additionally, or alternatively, in a multi-TRP scenario, for example for simultaneous PUSCH+PUCCH transmission on multiple panels, the WTRU 1300 may identify the power capability for a panel. Priorities (e.g., existing priorities) may include one or more of a PRACH transmission on the PCell, a PUCCH transmission with HARQ-ACK information, an SR transmission with HARQ-ACK information, a PUSCH transmission with HARQ-ACK information; a PUCCH transmission with CSI, a PUSCH transmission with CSI, a PUSCH transmission without HARQ-ACK information and/or CSI, a SRS transmission (e.g., with aperiodic SRS having higher priority than semi-persistent and/or periodic SRS); and/or a PRACH transmission (e.g., on a serving cell other than the PCell).

What is claimed is:

1-20. (canceled)

21. A wireless transmit/receive unit (WTRU) comprising:
a processor configured to:
receive a first set of simultaneous uplink grants to transmit first simultaneous transmissions using a first set of two or more beams;
transmit a first power headroom report (PHR) including a first power sharing indication indicating a first power sharing status for the first simultaneous transmissions;
receive a second set of simultaneous uplink grants to transmit second simultaneous transmissions using a second set of two or more beams;
determine a second power sharing status for the second simultaneous transmissions; and
transmit a second PHR based on the determined second power sharing status being different than the first power sharing status.

22. The WTRU of claim 21, wherein the second PHR comprises a second power sharing indication indicating the second power sharing status for the second simultaneous transmissions.

23. The WTRU of claim 21, wherein the first PHR comprises a first maximum power associated with a first beam and a second maximum power associated with a second beam, and wherein the first beam and the second beam are comprised in the first set of two or more beams.

24. The WTRU of claim 23, wherein the second PHR comprises a third maximum power associated with a third beam and a fourth maximum power associated with a fourth beam, and wherein the third beam and the fourth beam are comprised in the second set of two or more beams.

25. The WTRU of claim 21, wherein a value of the first power sharing status and the second power sharing status comprises true or a value of the first power sharing status and the second power sharing status comprises false.

26. The WTRU of claim 21, wherein the first beam and the third beam are the same beam.

27. The WTRU of claim 21, wherein the first set of two or more beams are comprised in a first panel group.

28. The WTRU of claim 27, wherein a value of a first power sharing status is based on the first set of two or more beams being comprised in a first panel group.

29. The WTRU of claim 28, wherein the value of the first power sharing status is further based on an angle between the two or more beams.

30. The WTRU of claim 21, wherein the processor is configured to periodically transmit the first PHR report based on a timer.

31. A method performed by a wireless transmit/receive unit (WTRU), the method comprising:
receiving a first set of simultaneous uplink grants to transmit first simultaneous transmissions using a first set of two or more beams;
transmitting a first power headroom report (PHR) including a first power sharing indication indicating a first power sharing status for the first simultaneous transmissions;
receiving a second set of simultaneous uplink grants to transmit second simultaneous transmissions using a second set of two or more beams;
determining a second power sharing status for the second simultaneous transmissions; and
transmitting a second PHR based on the determined second power sharing status being different than the first power sharing status.

32. The method of claim 31, wherein the second PHR comprises a second power sharing indication indicating the second power sharing status for the second simultaneous transmissions.

33. The method of claim 31, wherein the first PHR comprises a first maximum power associated with a first beam and a second maximum power associated with a second beam, and wherein the first beam and the second beam are comprised in the first set of two or more beams.

34. The method of claim 33, wherein the second PHR comprises a third maximum power associated with a third beam and a fourth maximum power associated with a fourth beam, and wherein the third beam and the fourth beam are comprised in the second set of two or more beams.

35. The method of claim 31, wherein a value of the first power sharing status and the second power sharing status comprises true or a value of the first power sharing status and the second power sharing status comprises false.

36. The method of claim 31, wherein the first beam and the third beam are the same beam.

37. The method of claim 31, wherein the first set of two or more beams are comprised in a first panel group.

38. The method of claim 37, wherein a value of a first power sharing status is based on the first set of two or more beams being comprised in a first panel group.

39. The method of claim 38, wherein the value of the first power sharing status is further based on an angle between the two or more beams.

40. The method of claim 31, comprising periodically transmitting the first PHR report based on a timer.
